(19) United States
(12) Patent Application Publication
(10) Pub. No.: US 2026/0270852 A1
(43) Pub. Date: Sep. 10, 2026

(54) NETWORK NODES, USER EQUIPMENT AND METHODS PERFORMED THEREIN

(71) Applicant: Telefonaktiebolaget LM Ericsson (publ), Stockholm (SE)

(72) Inventors: Stefan ROMMER, Vastra Frolunda (SE); Maria Belen PANCORBO MARCOS, Madrid (ES)

(21) Appl. No.: 19/135,634

(22) PCT Filed: Jan. 9, 2024
(86) PCT No.: PCT/EP2024/050374

§ 371 Date: Jun. 4, 2025

Related U.S. Application Data
(60) Provisional application No. 63/479,004, filed on Jan. 9, 2023.

(51) Int. Cl. H04W 48/16; H04W 60/00

(52) U.S. Cl. CPC H04W 48/16; H04W 60/002

(57) ABSTRACT

Embodiments herein provide, for example, a method performed by a first network node (16), such as the NRF or UDR, for handling communication of a user equipment, UE, (10) in a communication network. The first network node registers a supported slice specific policy delivery of a third network node (18), such as a PCF; and provides to a second network node (17), such as an AMF, an indication of the supported slice specific policy delivery of the third network node (18).

### TECHNICAL FIELD

Embodiments herein relate to network nodes, a user equipment (UE), and methods performed therein regarding wireless communication. Furthermore, a computer program product and a computer readable storage medium are also provided herein. In particular, embodiments herein relate to handling communication of UEs in a communication network.

### BACKGROUND

In a typical communication network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions. NR is connected to the 5G Core Network (5GC) which comprises a number of Network Functions (NF) such as Session Management Function (SMF), Access Management Function (AMF), Authentication Service Function (AUSF), Policy Control Function (PCF), Unified Data Manager (UDM), Network Repository Function (NRF), Network Exposure Function (NEF), just to mention some. In the 5GC, NFs can discover other NFs by using a discovery service provided by the NRF.

A network slice supports the communication service of a particular connection type with a specific way of handling control-plane and user-plane for the service. A 5G slice could be composed by a collection of 5G network functions and possibly specific radio access technology (RAT) with specific settings that are combined together for the specific use case or business model. It should be noted that not all slices contain the same network functions. A specific network service can be instantiated according to on demand requirements for third party users/operators and the business policy between the network service providers and network service consumers. Thus, an operator may have one physical network infrastructure and one pool of frequency bands, which may support many separate virtualized networks, also called network slices. Each network slice may have unique characteristics for meeting the specific requirements of the use case/s the network slice serves.

A key function of 5G Core network is to allow for flexibility in the network service creation, making use of different network functions suitable for the offered service in a specific network slice, e.g. Evolved Mobile Broadband (MBB), Massive Machine Type Communication (MTC), Critical MTC, Enterprise, etc. Slicing can also be used to isolate different services in an operator's network.

When the UE accesses, via non-3GPP access, to 5G core (5GC), it can connect via trusted non-3GPP access, such as a trusted Non-3GPP Gateway Function (TNGF), untrusted non-3GPP access such as non-3GPP Inter-Working Function (N3IWF), or wireline Access Gateway Function (W-AGF). N3IWF mainly provides a secure gateway to operator's 5G network for non-3GPP access. In Release (Rel)-15/16, there was a single non-3GPP Tracking Area Identifier (TAI) for all non-3GPP accesses, i.e., all N3WIFs/TNGFs/W-AGFs support the same TAI. Since the set of supported slices, identified by Serving Network Slice Selection Assistance Information (S-NSSAI), need to be homogenous per TAI, all non-3GPP accesses have to support the same set of S-NSSAIs.

During Rel-17 it was agreed that each N3IWF, TNGF and W-AGF may support a separate TAI. This enables a deployment where different N3WIFs/TNGFs/W-AGFs support different sets of slices. However, during rel-17 there were no enhancements to the procedures for how a UE selects or is assigned a N3IWF, TNGF or W-AGF. That means that the UE may be assigned a N3IWF, TNGF or W-AGF that does not support the set of slices requested by the UE. This may lead to a process wherein a UE is rejected from registering to the 5GC.

This will not be improved in Rel-18 in the 5G Wireless Wireline Convergence (5WWC) study/work item. Taking untrusted access as an example, enhancements have been agreed where the UE policies for N3IWF selection, in access network discovery and selection policy (ANDSP), provided from the PCF to the UE are enhanced to contain slicing information per N3IWF.

In addition, it has been agreed that the PCF can request the AMF to update the UE policies for N3IWF selection during the registration procedure. This is done in case the UE has selected a N3IWF that does not support any slices needed by the UE and AMF thus has to reject the UE. To avoid a deadlock where the UE gets stuck on selecting such N3IWF, the PCF can provide updated policies to the UE before the AMF rejects the registration request from the UE. This is captured in step 9 in the Registration call flow below (from TR 23.700-17, clause 6.15.3) shown in FIG. 1b.
1. The UE connects to an untrusted non-3GPP Access Network with any appropriate authentication procedure and it is assigned an IP address. For example, a non-3GPP authentication method can be used, e.g., no authentication, in the case of a free Wireless Local Area Network (WLAN), Extensible Authentication Protocol (EAP) with pre-shared key, username/password, etc. When the UE decides to attach to 5GC network, the UE selects an N3IWF in a 5G Public Land Mobile Network (PLMN) as described in clause 6.15.2.2.

Steps 2 to 7 do not require specification changes with regard to 3GPP Rel-17.
2. The UE proceeds with the establishment of an IPsecurity (IPsec) Security Association (SA) with the selected N3IWF by initiating an Internet Key Exchange (IKE) initial exchange according to RFC 7296 [3]. After step 2, all subsequent IKE messages are encrypted and integrity protected by using the IKE SA established in this step.
3. The UE shall initiate an IKE_AUTH exchange by sending an IKE_AUTH request message. The AUTH payload is not included in the IKE_AUTH request message, which indicates that the IKE_AUTH exchange shall use EAP signalling, in this case EAP-5G signalling. If the UE supports MOBIKE, it shall include a Notify payload in the IKE_AUTH request, as specified in RFC 4555 [40], indicating that MOBIKE is supported. In addition, as specified in TS 33.501 [9], if the UE is provisioned with the N3IWF root certificate, it shall include the CERTREQ payload within the IKE_AUTH request message to request the N3IWF's certificate.
4. The N3IWF responds with an IKE_AUTH response message, which includes an EAP-Request/5G-Start packet. The EAP-Request/5G-Start packet informs the UE to initiate an EAP-5G session, i.e., to start sending Non Access Stratum (NAS) messages encapsulated within EAP-5G packets. If the N3IWF has received a CERTREQ payload from the UE, the N3IWF shall include the CERT payload in the IKE_AUTH response message containing the N3IWF's certificate. How the UE uses the N3IWF's certificate is specified in TS 33.501 [9].
5. The UE shall send an IKE_AUTH request, which includes an EAP-Response/5G-NAS packet that contains the Access Network parameters (AN parameters) and a Registration Request message. The AN parameters contain information that is used by the N3IWF for selecting an AMF in the 5G core network. This information includes, e.g., the Globally Unique AMF Identifier (GUAMI), the Selected PLMN ID (or PLMN ID and Network Identifier (NID), see clause 5.30 of TS 23.501 [2]), the Requested NSSAI and the Establishment cause. The Establishment cause provides the reason for requesting a signalling connection with 5GC. Whether and how the UE includes the Requested NSSAI as part of the AN parameters is dependent on the value of the Access Stratum Connection Establishment NSSAI Inclusion Mode parameter, as specified in clause 5.15.9 of TS 23.501 [2].
NOTE 1: The N3IWF does not send an EAP-Identity request because the UE includes its identity in the first IKE_AUTH. This is in line with clause 3.16 of RFC 7296 [3].
6. The N3IWF shall select an AMF based on the received AN parameters and local policy, as specified in clause 6.3.5 of TS 23.501 [2]. The N3IWF shall then forward the Registration Request received from the UE to the selected AMF within an N2 message. This message contains N2 parameters that include the Selected PLMN ID and the Establishment cause.
7. AMF initiates authentication and security procedure as defined in clause 4.12.2.2 of TS 23.502 [3]
8. The selected AMF determines whether the N3IWF connected with UE currently, named serving(S)-N3IWF, should be the serving N3WIF or a different target N3IWF (T-N3IWF) needs to be used. The AMF makes the determination considering the Requested S-NNSAI, the determined Allowed S-NSSAI, local configuration, etc.
Case a): S-N3IWF is not appropriate:
Editor's note: The procedures of step 9 and 10 will be clarified during normative phase.
9. If the AMF has determined in step 8 that the selected N3IWF is not appropriate, the AMF may
   either trigger the UE Policy Association Establishment procedure to provide the UE with updated N3IWF selection information described in clause 6.15.2.1, and then sends a Registration Reject message to the UE possibly providing target N3IWF information, e.g., Fully Qualified Domain Name (FQDN) and/or IP address;
   send a Registration Reject message to the UE providing target N3IWF information, e.g., FQDN and/or IP address, so that UE can use the target N3IWF information to select the target N3IWF to register to 5GC. For this, the AMF may determine a target N3IWF that supports the request NSSAI based on the list of supported Tracking Areas (TA) and the corresponding list of supported slices for each TA obtained in RAN Configuration Update procedure as specified in TS 38.413 [7]. The AMF keeps track that the UE needs updated N3IWF selection information in order to later trigger UE Policy Association Establishment procedure.
NOTE 2: Whether the updated ANDSP is provided to the UE using DL NAS transport or as part of the subsequent Registration Reject message can be determine by CT1.
10a. AMF sends a Registration Reject message to the UE. Optionally, if the AMF has determined in step 8 that the selected N3IWF is not appropriate, the AMF may provide target N3IWF information, e.g., FQDN and/or IP address, to the UE within Registration Reject message.
Case b): S-N3IWF is appropriate:
10.b If the AMF has determined in step 8 that the selected N3IWF is appropriate, AMF continues the registration procedure as defined in clause 4.12.2.2 and sends a Registration Accept to the UE. The AMF only includes S-NSSAIs supported by the selected N3IWF in the Accepted NSSAI for the UE, if the S-N3IWF is appropriate. The N3IWF forwards the NAS Registration Accept message to UE via the established signalling IPsec SA. If the NAS Registration Accept message is received by the N3IWF before the IPsec SA is established, the N3IWF shall store it and forward it to the UE only after the establishment of the signalling IPsec SA.
11. If the UE is rejected, the UE connects to the T-N3IWF if the UE has been provided with T-N3IWF information in the previous Registration Reject, otherwise the UE performs N3IWF selection again using the updated N3IWF selection information.

The description of steps 8-9 in TR 23.700-17, clause 6.15.3, are copied below:
8. The selected AMF determines whether the N3IWF connected with UE currently, named S-N3IWF, should be the serving N3WIF or a different target N3IWF (T-N3IWF) needs to be used. The AMF makes the determination considering the Requested S-NNSAI, the determined Allowed S-NSSAI, local configuration, etc.
Case a): S-N3IWF is not appropriate:
9. If the AMF has determined in step 8 that the selected N3IWF is not appropriate, the AMF may initiate the UE Policy Association Establishment procedure, trigger the PCF to provide the UE with updated N3IWF selection policies (described in clause 6.15.2.1) and request the PCF to notify the AMF when the UE has been updated with such policies. The AMF may set a timer, related with the maximum time the UE can wait for a registration accept/reject, at the expiry of which it will send a registration reject to the UE regardless of the policy update status.

When the UE has been updated with N3IWF selection policies, the PCF notifies the AMF, and the AMF sends a Registration Reject message to the UE.

If the PCF indicates a failure to update the UE or if the PCF does not notify the AMF when the UE has been updated with such policies, the AMF sends a Registration Reject message to the UE providing target N3IWF information, e.g., FQDN and/or IP address. so that UE can use the target N3IWF information to select the target N3IWF to register to 5GC.

### SUMMARY

As part of developing embodiments herein one or more problems have been identified. There may be two problems with the current state of art in 3GPP:
If the AMF selects a pre-Rel-18 PCF, not supporting this new Rel-18 feature, and activates the UE policy association to update the UE policies, as described in step 9 above, the legacy PCF may start the UE policy update but it will only provide legacy policies. This will not help the UE to select a N3IWF supporting the set of slices needed. It may also include a large set of policies, such as ANDSP, WLAN Selection Policy (WLANSP), UE Route Selection Policy (URSP) etc., and take several round-trips between UE and PCF, via AMF, which cause latencies for no reason.
If the AMF selects an upgraded PCF, this PCF can provide the right policies. However, since this is an exceptional case with policy delivery during a registration procedure the PCF should not make a general policy update towards the UE. Only the required N3IWF selection policies should be provided. Other policies can be sent in the normal way, i.e., after the UE has performed a successful registration.

An object of embodiments herein is to improve performance of a UE in a communication network.

According to an aspect the object is achieved, according to some embodiments herein, by providing a method performed by a first network node, such as an NRF, for handling communication of a UE in a communication network. The first network node registers a supported slice specific policy delivery of a network function or a third network node, such as a PCF. The first network node provides to a second network node an indication of the supported slice specific policy delivery of the network function or the third network node.

According to another aspect the object is achieved, according to some embodiments herein, by providing a method performed by a second network node, such as an AMF, for handling communication of a UE in a communication network. The second network node obtains, from a first network node, an indication of a supported slice specific policy delivery of a network function or a third network node. This allows the second network node to select a network function for a UE based on a requested supported slice specific policy delivery.

According to another aspect the object is achieved, according to some embodiments herein, by providing a method performed by a third network node, such as a PCF, for handling communication of a UE in a communication network. The third network node obtains, from a second network node, such as an AMF, an additional indication to inform the third network node that a UE policy is established for a purpose of untrusted non-3GPP access selection.

According to another aspect the object is achieved, according to some embodiments herein, by providing a method performed by a UE for handling communication of the UE in a communication network. The UE transmits one or more access indications, which one or more access indications indicate that policy for a trusted or untrusted non-3GPP Access Network, such as N3IWF, is needed or requested and provides a request indication of a requested S-NSSAI.

It is furthermore provided herein a computer program product comprising instructions, which, when executed on at least one processor, cause the at least one processor to carry out the method above, as performed by the UE, the first network node, the second network node, and the third network node, respectively. It is additionally provided herein a computer-readable storage medium, having stored thereon a computer program product comprising instructions which, when executed on at least one processor, cause the at least one processor to carry out the method according to the method above, as performed by the UE, the first network node, the second network node, and the third network node, respectively.

Furthermore, according to another aspect the object is achieved, according to some embodiments herein, by providing a first network node, a second network node, a third network node and a UE configured to perform the methods herein, respectively.

According to another aspect the object is achieved, according to some embodiments herein, by providing a first network node, such as the NRF or UDR, for handling communication of a UE in a communication network. The first network node is configured to register a supported slice specific policy delivery of a third network node; and provide to a second network node an indication of the supported slice specific policy delivery of the third network node.

According to another aspect the object is achieved, according to some embodiments herein, by providing a second network node, such as an AMF, for handling communication of a UE in a communication network. The second network node is configured to obtain, from a first network node, an indication of a supported slice specific policy delivery of a third network node such as a network function.

According to another aspect the object is achieved, according to some embodiments herein, by providing a third network node, such as a PCF, for handling communication of a UE in a communication network. The third network node is configured to obtain, from a second network node, such as an AMF, an additional indication to inform the third network node that a UE policy is established for a purpose of untrusted non-3GPP access selection.

According to another aspect the object is achieved, according to some embodiments herein, by providing a UE for handling communication of the UE in a communication network. The UE is configured to transmit one or more access indications, which one or more access indications indicate that policy for a trusted or untrusted non-3GPP Access Network is needed or requested and provides a request indication of a requested S-NSSAI.

The indication may be referred to as a capability indication and indicates that the network function or third network node, such as a PCF, supports slice specific policy delivery. The indication may be included in a PCF profile in an NRF. This may be retrieved by the AMF and allows the AMF to select a PCF supporting the slice specific policy delivery. If the AMF is not able to find any PCF supporting this feature, the AMF may not, for example, initiate UE policy establishment in step 9 described in the background above.

The additional indication, explicit or implicit, may be added from the second network node, such as the AMF, to the third network node, such as the PCF, to inform the third network node that the UE policy is established for the purpose of N3IWF selection purposes. This also implies that the UE policy session will soon thereafter be released. Corresponding information may also be provided in case of trusted non-3GPP access, but in that case the third network node will deliver policies for service set identifier (SSID) selection, such as WLANSP, and TNGF selection, such as ANDSP.

The second network node may also provide one or more targeted S-NSSAIs, as determined from Requested NSSAI, that are needed by the UE. This can guide the third network node to limit the amount of policies sent to the UE.

Embodiments herein disclose the indication such as a Capability in the PCF profile in the NRF, indicating that the PCF supports slice specific policy delivery. Furthermore, the additional indication from the AMF to the PCF during UE policy establishment, step 9 described in the background above, is disclosed. The additional indication indicates that the UE policy association is just for N3IWF (or TNGF) selection purposes. Embodiments herein avoid that policies are delivered to the UE during a registration procedure that anyway will be rejected. This will thus result in an improved performance of the UE in the communication network.

### BRIEF DESCRIPTION OF THE DRAWINGS

Embodiments will now be described in more detail in relation to the enclosed drawings, in which:

FIG. 1a shows a schematic architecture according to prior art;

FIG. 1b shows a schematic signalling scheme according to prior art;

FIG. 2a shows an overview depicting a communication network according to embodiments herein;

FIG. 2b shows a combined signalling scheme and flowchart according to embodiments herein;

FIG. 3 shows a flowchart illustrating a method performed by a first network node according to embodiments herein;

FIG. 4 shows a flowchart illustrating a method performed by a second network node according to embodiments herein;

FIG. 5 shows a flowchart illustrating a method performed by a third network node according to embodiments herein;

FIG. 6 shows a flowchart illustrating a method performed by a UE according to embodiments herein;

FIG. 7 shows a signalling scheme according to some embodiments herein;

FIG. 8 shows a block diagram depicting embodiments of a first network node according to embodiments herein;

FIG. 9 shows a block diagram depicting embodiments of a second network node according to embodiments herein;

FIG. 10 shows a block diagram depicting embodiments of a third network node according to embodiments herein;

FIG. 11 shows a block diagram depicting embodiments of a UE according to embodiments herein;

FIG. 12 schematically illustrates a telecommunication network connected via an intermediate network to a host computer;

FIG. 13 is a generalized block diagram of a host computer communicating via a base station with a user equipment over a partially wireless connection;

FIGS. 14, 15, 16, and 17 are flowcharts illustrating methods implemented in a communication system including a host computer, a base station and a user equipment; and

FIG. 18 shows a signalling scheme depicting some embodiments herein.

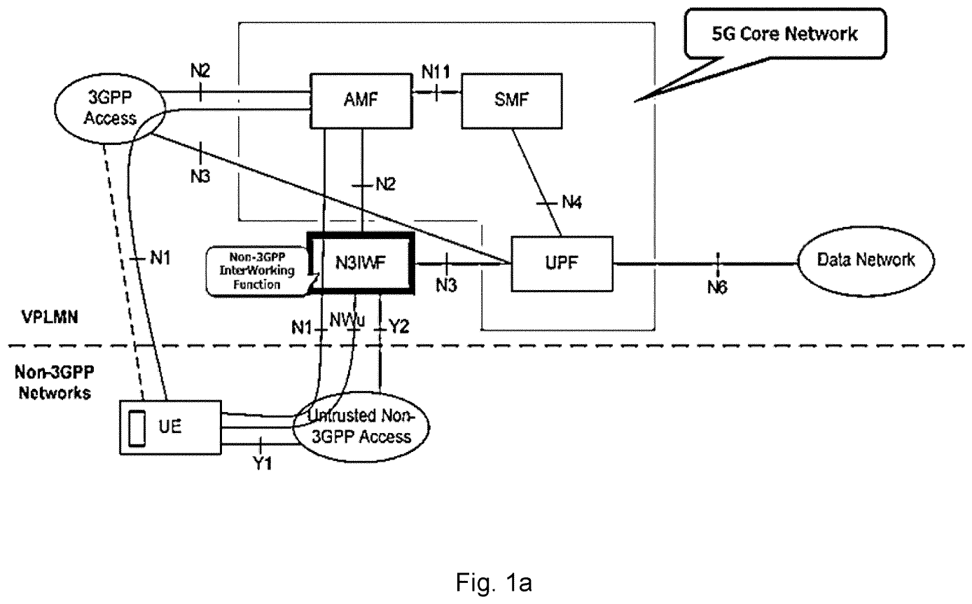

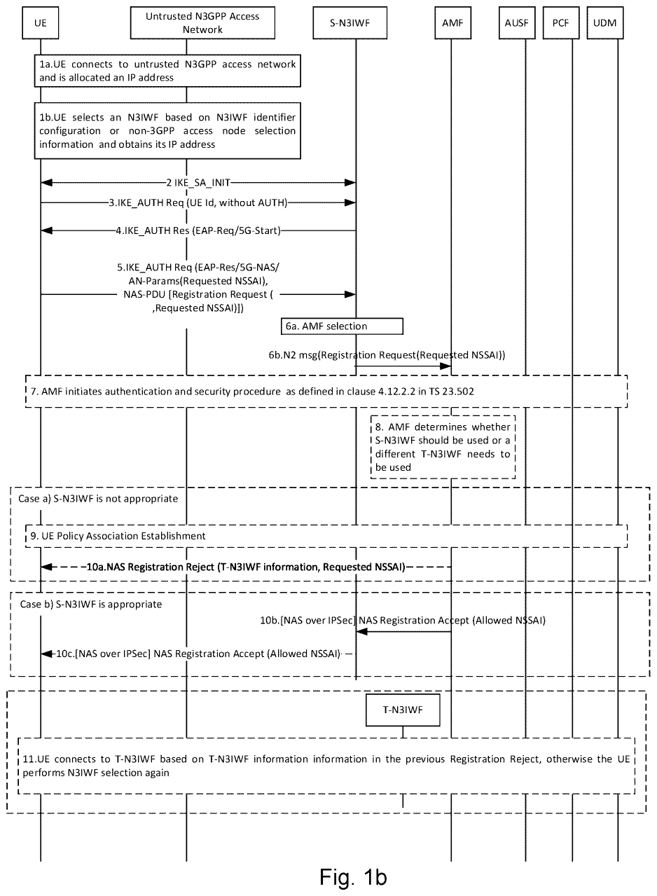

### DETAILED DESCRIPTION

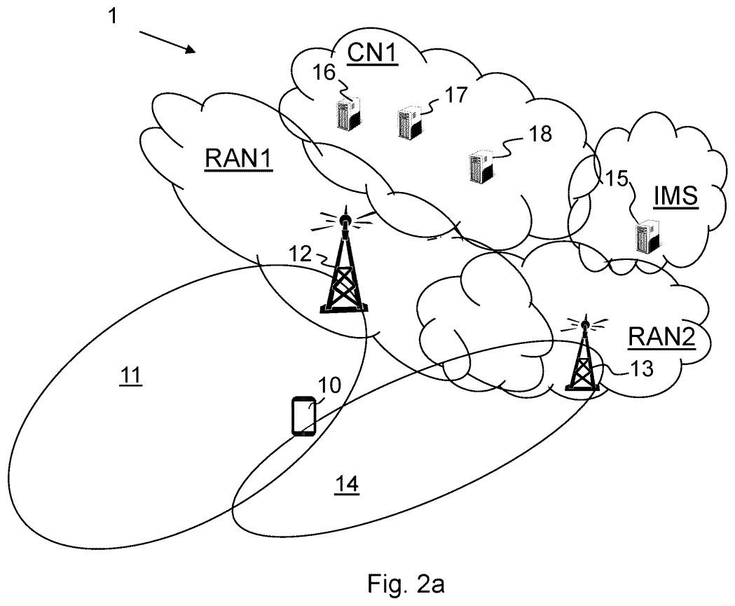

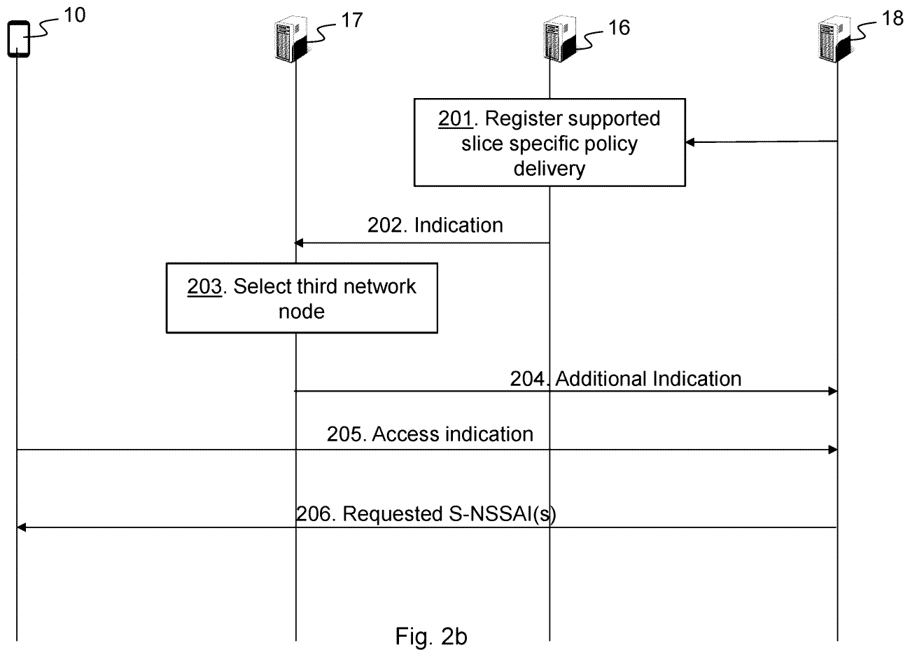

Embodiments herein relate to communication networks in general. FIG. 2a is a schematic overview depicting a communication network 1. The communication network 1 comprises one or more RANs and one or more CNs. The communication network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the communication network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. RAN, to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a first radio network node 12 or just radio network node, providing radio coverage over a geographical area, a first service area 11 or first cell, of a first RAT, such as NR, LTE, or similar. The first radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a WLAN access point or an Access Point Station (AP STA), a transmission arrangement of a radio base station, a stand-alone access point or any other network unit or node capable of communicating with a UE within the area served by the first radio network node depending e.g. on the first radio access technology and terminology used. The first radio network node may be referred to as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage. The first radio network node 12 may be of a first PLMN such as a home PLMN (HPLMN).

The communication network 1 comprises a second radio network node 13 or just radio network node, providing radio coverage over a geographical area, a second service area 14 or second cell, of a second RAT, such as NR, LTE, or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a WLAN access point or an AP STA, a transmission arrangement of a radio base station, a stand-alone access point or any other network unit or node capable of communicating with a wireless device within the area served by the second radio network node depending e.g. on the second radio access technology and terminology used. The second radio network node 13 may be referred to as a visiting radio network node or target radio network node, wherein the service area may be referred to as a visiting cell or target cell, and the second network node communicates with the UE in form of DL transmissions to the UE and UL transmissions from the UE. It should be noted that a service area may be denoted as cell, beam, beam group or similar to define an area of radio coverage. The second radio network node 13 may be of a second PLMN such as a visiting PLMN (VPLMN).

The communication network may comprise an IP Multimedia Subsystem (IMS) network comprising one or more IMS nodes 15. Thus, the IMS network may comprise several network entities, some of which are discussed here. Each PLMN may have its own IMS, a first IMS node at the first PLMN and a second IMS node at the second PLMN.

An IMS node may comprise:

A Home Subscriber Server (HSS); an HSS is a subscriber database comprising subscriber profiles, performs authentication and authorization, and provides information on services provisioned for subscribers and information on the location and IP address of a subscriber.

A Serving Call Session Control Function (S-CSCF); an S-CSCF is a session initiating protocol (SIP) server and is the central signaling node in the IMS network and performs session control services for the UE. It handles SIP registrations and is responsible for forwarding SIP messages to the correct application server. The S-CSCF may behave as a SIP-proxy, i.e. it accepts requests and services them internally or forwards them.

Another entity is an outbound proxy of the UE 10, which is referred to as a Proxy-Call/Session Control Function (P-CSCF). The P-CSCF routes requests to other CSCFs such as S-CSCFs.

Interrogating Call Session Control Function (I-CSCF); an I-CSCF is a SIP server and located at the edge of an administrative domain. Its IP address is published in the Domain Name System (DNS) of the domain, so that remote servers can find it and use it as a forwarding point for SIP packets to this domain.

The communication network 1 further comprises a number of core network nodes providing, e.g., in NR, network functions (NF) or actually instantiations of NFs also referred to as NF instances, such as a first network node 16 providing, for example, an instantiation of an NRF, a second network node 17 providing an instantiation of an AMF, and a third network node 18 providing, for example, an instantiation of an PCF, or any other NF instances in the communication network 1. The different NF instances may have different tasks. Other functions may be for LTE such as Mobility Management Entity (MME) or similar.

The respective network node may be a standalone server, a cloud-implemented server, a distributed server or processing resources in a server farm or same node. Embodiments herein may be implemented as physical bare metal, virtual or cloud native such as Kubernetes environment in, e.g., hyper-cloud networks.

Embodiments herein disclose, for example, an indication, such as a Capability, in a PCF profile in the first network node, such as an NRF, that the third network node, such as the PCF, supports slice specific policy delivery, and an additional indication may be provided from the second network node, such as an AMF, to the third network node during UE policy establishment indicating that the UE policy association is just for non-trusted and/or trusted non-3GPP network selection purposes. Embodiments herein avoid that policies are delivered to the UE 10 during a registration procedure that anyway will be rejected since the second network node is enable to select a third network node for the UE 10. This will thus result in an improved performance of the UE 10 in the communication network 1.

FIG. 2b is a combined flowchart and signalling scheme according to some embodiments herein.

Action 201. The first network node 16 registers a supported slice specific policy delivery of a network function or the third network node 18. For example, the first network node 16 may store a capability indication that indicates that a network function or the third network node 18, such as a PCF, supports slice specific policy delivery.

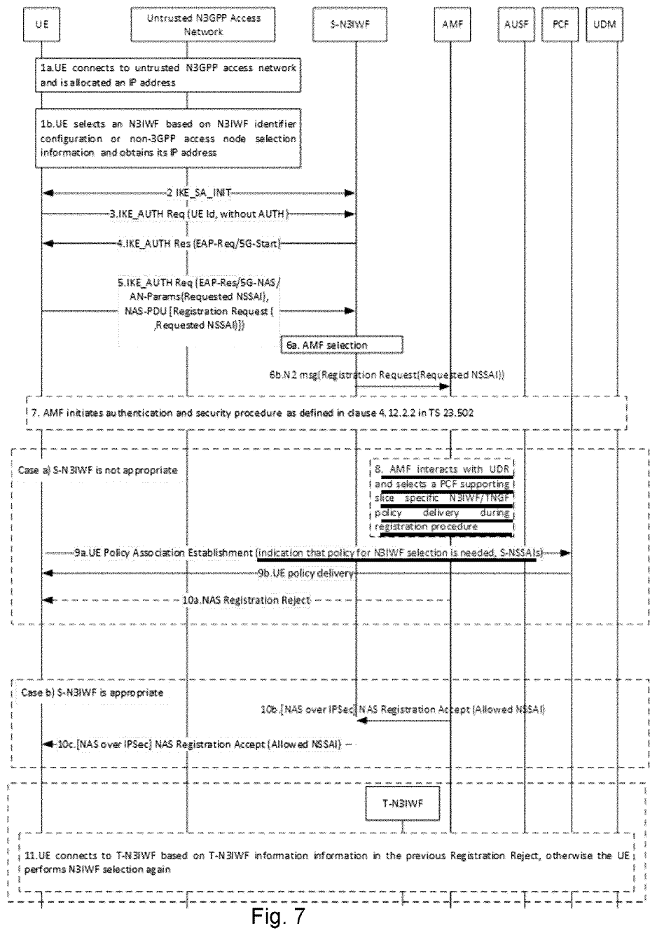

Action 202. The first network node 16 provides to the second network node 17 the indication of the supported slice specific policy delivery of the network function or third network node 18. Thus, the second network node 17 obtains from the first network node 16 the indication of the supported slice specific policy delivery of the third network node 18. The indication may indicate that the third network node 18 supports slice-specific N3IWF and/or TNGF selection policies. The indication may comprise a real value or an index value of a configured table/values, see action 8 in FIG. 7.

Action 203. The second network node 17 may select a third network node 18 or a network function such as PCF supporting a specific slice specific policy delivery based on the obtained indication, see action 8 in FIG. 7.

Action 204. The second network node 17 may provide, to the third network node 18 such as the PCF, an additional indication to inform the third network node 18 that a UE policy is established for a purpose of untrusted non-3GPP access selection. Thus, the third network node 18 obtains, from the second network node 17 such as the AMF, the additional indication to inform the third network node 18 that a UE policy is established for a purpose of untrusted non-3GPP access selection.

Action 205. The UE 10 transmits one or more access indications, which access indications indicate that policy for trusted or untrusted non-3GPP Access Network such as N3IWF is needed or requested and may provide indication(s) of requested S-NSSAI(s). The access indication may comprise a real value or an index value of a configured table/values see action 9a in FIG. 7.

Action 206. The third network node 18 such as the PCF, may reply with requested S-NSSAI(s). The one or more indications may comprise a real value or an index value of a configured table/values. The UE 10 may receive one or more indications of targeted S-NSSAIs, as determined from Requested NSSAI, that are needed by the UE 10, see action 9b in FIG. 7.

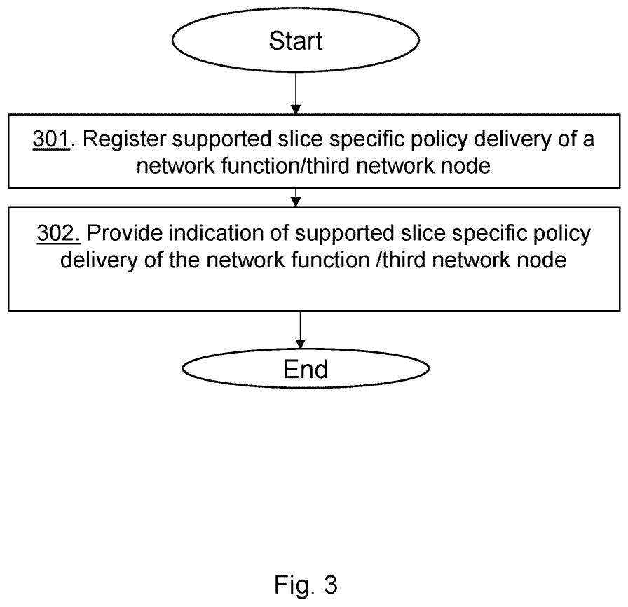

The method actions performed by the first network node 16, such as the NRF, for handling communication of the UE 10 in the communication network, for example, handling support of slice specific policy delivery, according to embodiments herein will now be described with reference to a flowchart depicted in FIG. 3. The actions do not have to be taken in the order stated below, but may be taken in any suitable order.

Action 301. The first network node 16 registers a supported slice specific policy delivery of a network function or the third network node 18. For example, the first network node 16 may store a capability indication that indicates that a network function or the third network node 18, such as a PCF, supports slice specific policy delivery.

Action 302. The first network node 16 provides to the second network node 17 the indication of the supported slice specific policy delivery of the network function or third network node 18. The indication may be included in a PCF profile in the first network node 16 and may be sent to the second network node 17 upon request. The indication may comprise a real value or an index value of a configured table/values. The indication may comprise a simple Boolean indicating of the third network node 18 supports slice-specific N3IWF and/or TNGF selection policies. This would then imply that the third network node 18 supports all the required functionality related to slice-specific N3IWF and/or TNGF policies. The indication may comprise a simple Boolean indicating of the third network node 18 supports delivery of UE policies, such as ANDSP, during the Registration procedure. This is the capability from the second network node 17 perspective when selecting UE third network node 18 in this scenario. The indication may comprise a structured information element (IE) indicating separate values for different functionalities. There may be separate capability indications for: a first value indicating that PCF supports delivery of UE policies (ANDSP) for N3IWF selection during the Registration procedure; a second value indicating that PCF supports delivery of UE policies (ANDSP) for TNGF selection during the Registration procedure; a third value indicating that PCF supports delivery of UE policies (WLANSP) for SSID selection during the Registration procedure.

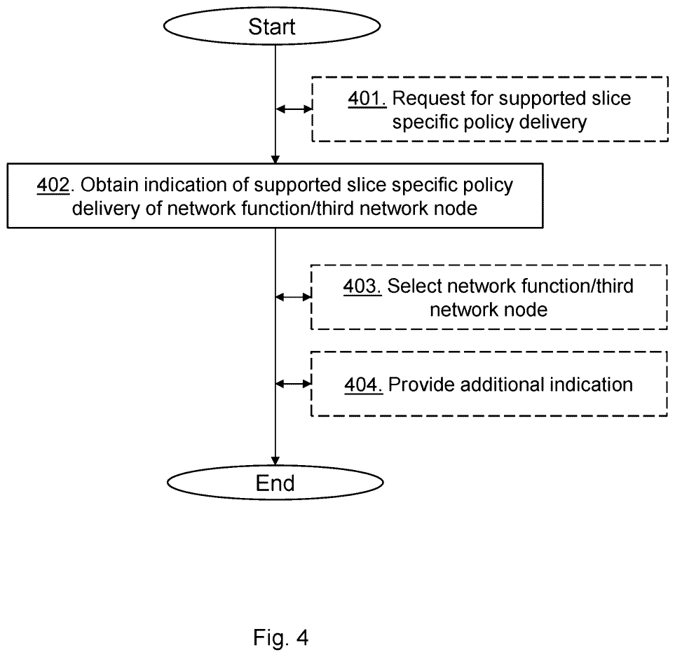

The method actions performed by the second network node 17, such as the AMF, for handling communication of the UE 10 in the communication network, for example, handling support of slice specific policy delivery, according to embodiments herein will now be described with reference to a flowchart depicted in FIG. 4. The actions do not have to be taken in the order stated below, but may be taken in any suitable order. Actions performed in some embodiments are marked with dashed boxes.

Action 401. The second network node 17 may request from the first network node 16 for supported slice specific policy delivery.

Action 402. The second network node 17 obtains from the first network node 16 the indication of the supported slice specific policy delivery of the third network node 18. The indication may indicate that the third network node 18 supports slice-specific N3IWF and/or TNGF selection policies. The indication may comprise a real value or an index value of a configured table/values, see above. The indication may comprise a simple Boolean indicating of the third network node 18 supports slice-specific N3IWF and/or TNGF selection policies. This would then imply that the third network node 18 supports all the required functionality related to slice-specific N3IWF and/or TNGF policies. The indication may comprise a simple Boolean indicating of the third network node 18 supports delivery of UE policies, such as ANDSP, during the Registration procedure. The indication may comprise the structured IE indicating separate values for different functionalities. There may be separate capability indications for: a first value indicating that PCF supports delivery of UE policies (ANDSP) for N3IWF selection during the Registration procedure; a second value indicating that PCF supports delivery of UE policies (ANDSP) for TNGF selection during the Registration procedure; a third value indicating that PCF supports delivery of UE policies (WLANSP) for SSID selection during the Registration procedure.

Action 403. The second network node 17 may select a third network node 18 or a network function such as PCF supporting a specific slice specific policy delivery based on the obtained indication.

Action 404. The second network node 17 may provide, to the third network node 18 such as the PCF, the additional indication to inform the third network node 18 that a UE policy is established for a purpose of untrusted non-3GPP access selection. The additional indication may comprise a real value or an index value of a configured table/values. The second network node 17 may further provide information such as a further indication in case of trusted non-3GPP access, in that case the second network node 17 may transmit a further indication of deliver policy for service set identifier (SSID) selection, such as WLANSP, and TNGF selection, such as ANDSP. The second network node 17 may further transmit one or more indications of targeted S-NSSAIs, as determined from the Requested NSSAI, that are needed by the UE 10. This can guide the third network node 18 to limit the amount of policies sent to the UE 10. The further indication and/or the one or more indications may comprise a real value or an index value of a configured table/values.

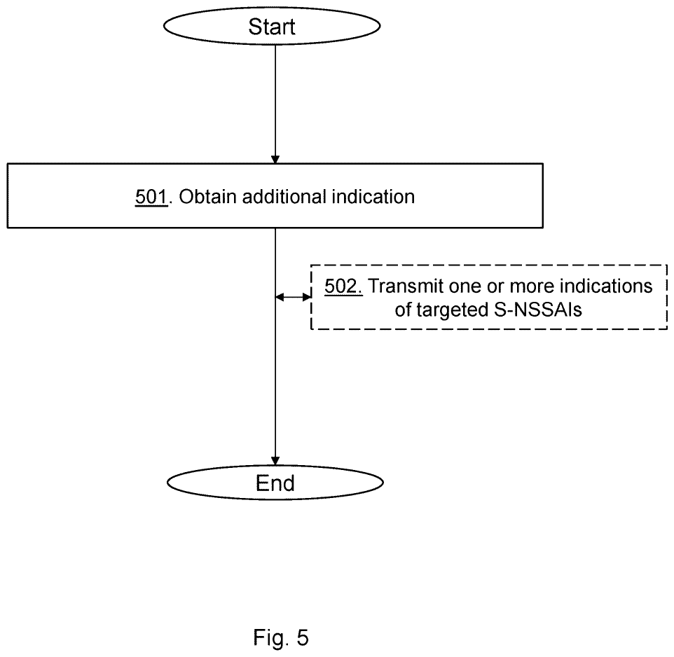

The method actions performed by the third network node 18, such as the PCF, for handling communication of the UE 10 in the communication network, for example, handling support of slice specific policy delivery, according to embodiments herein will now be described with reference to a flowchart depicted in FIG. 5. The actions do not have to be taken in the order stated below, but may be taken in any suitable order. Actions performed in some embodiments are marked with dashed boxes.

Action 501. The third network node 18 obtains, from the second network node 17 such as the AMF, the additional indication to inform the third network node 18 that a UE policy is established for a purpose of untrusted non-3GPP access selection. The third network node 18 may receive information such as a further indication in case of trusted non-3GPP access, in that case the third network node 18 may receive the further indication of deliver policy for SSID selection, such as WLANSP, and TNGF selection, such as ANDSP. The third network node 18 may further receive one or more indications of targeted S-NSSAIs, as determined from the Requested NSSAI, that are needed by the UE 10. This can guide the third network node 18 to limit the amount of policies sent to the UE 10.

Action 502. The third network node 18 may transmit to the UE 10 one or more indications of targeted S-NSSAIs, as determined from Requested NSSAI, that are needed by the UE 10. The additional indication and/or the one or more indications may comprise a real value or an index value of a configured table/values.

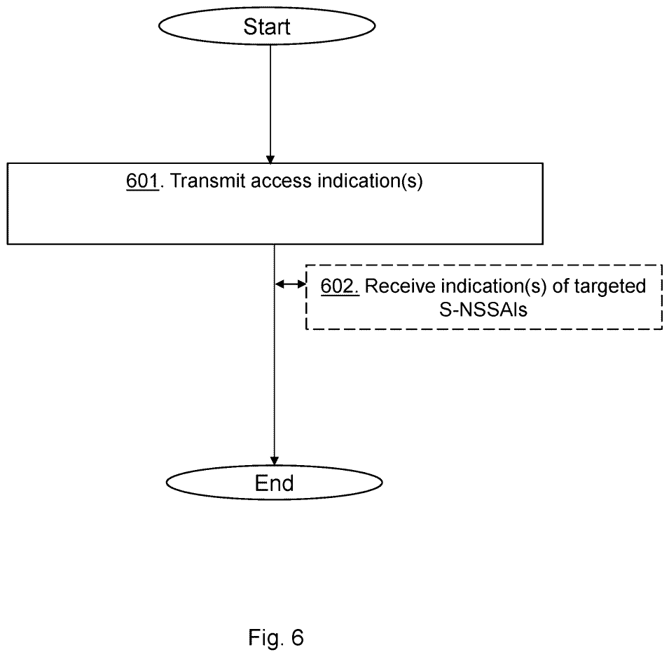

The method actions performed by the UE 10 for handling communication of the UE 10 in the communication network, for example, handling support of slice specific policy delivery, according to embodiments herein will now be described with reference to a flowchart depicted in FIG. 6. The actions do not have to be taken in the order stated below, but may be taken in any suitable order. Actions performed in some embodiments are marked with dashed boxes.

Action 601. The UE 10 transmits one or more access indications, which access indications indicate that policy for trusted or untrusted non-3GPP Access Network such as N3IWF is needed or requested and provides a request indication of requested S-NSSAI or S-NSSAIs. The access indication may comprise a real value or an index value of a configured table/values.

Action 602. The UE 10 may receive one or more indications of targeted S-NSSAIs, as determined from requested NSSAI, that are needed by the UE 10. The third network node 18 such as the PCF, may reply with requested S-NSSAI(s) to the UE 10. The one or more indications may comprise a real value or an index value of a configured table/values.

Referring to FIG. 7, wherein the first network node 16 is exemplified as an NRF, the second network node 17 is exemplified as an AMF, and the third network node 18 is exemplified as a PCF. Embodiments herein introduce a new capability in the PCF profile in the NRF that a PCF supports slice specific policy delivery. There are different ways how this policy can be included in the PCF's NRF profile, for example:
Alt. 1. A simple Boolean indicating of the PCF supports slice-specific N3IWF and TNGF selection policies. This would then imply that the PCF supports all the required functionality related to slice-specific N3IWF and/or TNGF policies.
Alt. 2. A simple Boolean indicating that the PCF supports delivery of UE policies (ANDSP) during the Registration procedure. This is the capability from AMF perspective when selecting UE PCF in this scenario.
Alt. 3. A structured IE indicating separate values for different functionalities. There could be separate capability indications for:
   i. PCF supports delivery of UE policies, such as ANDSP, for N3IWF selection during the Registration procedure,
   ii. PCF supports delivery of UE policies, such as ANDSP, for TNGF selection during the Registration procedure.
   iii. PCF supports delivery of UE policies, such as WLANSP, for SSID selection during the Registration procedure.
   iv. Etc

The example below shows Alt. 2 and Alt. 3 underlined.

| Table 6.1.6.2.20-1: | | | | |
|---|---|---|---|---|
| Definition of type | | | | |
| PcfInfoAttribute name | Data type | P | Cardinality | Description |
| groupId | NfGroupId | O | 0 . . . 1 | Identity of the PCF group that is served by the PCF |
| | | | | instance. |
| | | | | If not provided, the PCF instance does not pertain to |
| | | | | any PCF group. |
| | | | | (NOTE) |
| dnnList | array(Dnn) | O | 1 . . . N | DNNs supported by the PCF. The DNN shall contain |
| | | | | the Network Identifier and it may additionally contain |
| | | | | an Operator Identifier. If the Operator Identifier is not |
| | | | | included, the DNN is supported for all the PLMNs in |
| | | | | the plmnList of the NF Profile. |
| | | | | If not provided, the PCF can serve any DNN. |
| supiRanges | array(SupiRange) | O | 1 . . . N | List of ranges of SUPIs that can be served by the |
| | | | | PCF instance. |
| | | | | (NOTE) |
| gpsiRanges | array(IdentityRange) | O | 1 . . . N | List of ranges of GPSIs that can be served by the |
| | | | | PCF instance. |
| | | | | (NOTE) |
| rxDiamHost | DiameterIdentity | C | 0 . . . 1 | This IE shall be present if the PCF supports Rx |
| | | | | interface. |
| | | | | When present, this IE shall indicate the Diameter |
| | | | | host of the Rx interface for the PCF. |
| rxDiamRealm | DiameterIdentity | C | 0 . . . 1 | This IE shall be present if the PCF supports Rx |
| | | | | interface. |
| | | | | When present, this IE shall indicate the Diameter |
| | | | | realm of the Rx interface for the PCF. |
| v2xSupportInd | boolean | O | 0 . . . 1 | Indicates whether V2X Policy/Parameter |
| | | | | provisioning is supported by the PCF. |
| | | | | true: Supported |
| | | | | false (default): Not Supported |
| proseSupportInd | boolean | O | 0 . . . 1 | Indicates whether ProSe capability is supported by |
| | | | | the PCF. |
| | | | | true: Supported |
| | | | | false (default): Not Supported |
| proseCapability | ProseCapability | C | 0 . . . 1 | This IE shall be present if the PCF supports ProSe |
| | | | | Capability. |
| | | | | When present, this IE shall indicate the supported |
| | | | | ProSe Capability by the PCF. |
| v2xCapability | V2xCapability | C | 0 . . . 1 | This IE shall be present if the PCF supports V2X |
| | | | | Capability. |
| | | | | When present, this IE shall indicate the supported |
| | | | | V2X Capability by the PCF. |
| Alt 2: | boolean | C | 0 . . . 1 | Indicates whether delivery of N3IWF/TNGF/SSID |
| UE policy delivery | | | | selection policies are supported during Registration |
| | | | | procedure. |
| | | | | true: Supported |
| | | | | false (default): Not Supported |
| Alt 3: | UEPoCapability | O | 0 . . . 1 | This IE indicates capabilities related to UE policies |
| UE policy capability | | | | and UE policy delivery |

(NOTE)
If none of these parameters are provided, the PCF can serve any SUPI or GPSI managed by the PLMN of the PCF instance. If “supiRanges” and “gpsiRanges” attributes are absent, and “groupId” is present, the SUPIs / GPSIs served by this PCF instance is determined by the NRF (see 3GPP TS 23.501 [2], clause 6.2.6.2).

TABLE 2
Definition of type UEPoCapability

| Attribute name | Data type | P | Cardinality | Description |
|---|---|---|---|---|
| N3IWF delivery | boolean | O | 0 . . . 1 | When present, this IE shall indicate whether the PCF |
| | | | | supports delivery of N3IWF selection policies during |
| | | | | the registration procedure |
| TNGF delivery | boolean | O | 0 . . . 1 | When present, this IE shall indicate whether the PCF |
| | | | | supports delivery of TNGF selection policies during |
| | | | | the registration procedure |
| SSID delivery | boolean | O | 0 . . . 1 | When present, this IE shall indicate whether the PCF |
| | | | | supports delivery of SSID selection policies during |
| | | | | the registration procedure |

A call flow in FIG. 7 is provided and described below wherein claimed aspects are shown underlined.
1a-1b. The UE 10 connects to an untrusted non-3GPP Access Network with any appropriate authentication procedure, and it is assigned an IP address. For example, a non-3GPP authentication method can be used, e.g., no authentication (in the case of a free WLAN), EAP with pre-shared key, username/password, etc. When the UE 10 decides to attach to 5GC network, the UE 10 selects an N3IWF in a 5G PLMN as described in clause 6.15.2.2.
Steps 2 to 7 do not require specification changes with regard to 3GPP Rel-17.
2. The UE 10 proceeds with the establishment of an IPsec Security Association (SA) with the selected N3IWF by initiating an IKE initial exchange according to RFC 7296 [3]. After step 2, all subsequent IKE messages are encrypted and integrity protected by using the IKE SA established in this step.
3 The UE 10 shall initiate an IKE_AUTH exchange by sending an IKE_AUTH request message. The AUTH payload is not included in the IKE_AUTH request message, which indicates that the IKE_AUTH exchange shall use EAP signalling (in this case EAP-5G signalling). If the UE supports MOBIKE, it shall include a Notify payload in the IKE_AUTH request, as specified in RFC 4555 [40], indicating that MOBIKE is supported. In addition, as specified in TS 33.501 [9], if the UE 10 is provisioned with the N3IWF root certificate, it shall include the CERTREQ payload within the IKE_AUTH request message to request the N3IWF's certificate.
4. The N3IWF responds with an IKE_AUTH response message, which includes an EAP-Request/5G-Start packet. The EAP-Request/5G-Start packet informs the UE 10 to initiate an EAP-5G session, i.e., to start sending NAS messages encapsulated within EAP-5G packets. If the N3IWF has received a CERTREQ payload from the UE, the N3IWF shall include the CERT payload in the IKE_AUTH response message containing the N3IWF's certificate. How the UE 10 uses the N3IWF's certificate is specified in TS 33.501 [9].
5. The UE 10 shall send an IKE_AUTH request, which includes an EAP-Response/5G-NAS packet that contains the Access Network parameters (AN parameters) and a Registration Request message. The AN parameters contain information that is used by the N3IWF for selecting an AMF in the 5G core network. This information includes e.g. the GUAMI, the Selected PLMN ID (or PLMN ID and NID, see clause 5.30 of TS 23.501 [2]), the Requested NSSAI and the Establishment cause. The Establishment cause provides the reason for requesting a signalling connection with 5GC. Whether and how the UE includes the Requested NSSAI as part of the AN parameters is dependent on the value of the Access Stratum Connection Establishment NSSAI Inclusion Mode parameter, as specified in clause 5.15.9 of TS 23.501 [2].
NOTE 1: The N3IWF does not send an EAP-Identity request because the UE includes its identity in the first IKE_AUTH. This is in line with clause 3.16 of RFC 7296 [3].
6. The N3IWF shall select an AMF based on the received AN parameters and local policy, as specified in clause 6.3.5 of TS 23.501 [2]. The N3IWF shall then forward the Registration Request received from the UE to the selected AMF within an N2 message. This message contains N2 parameters that include the Selected PLMN ID and the Establishment cause.
7. AMF initiates authentication and security procedure as defined in clause 4.12.2.2 of TS 23.502 [3]
8: The AMF discovers and selects a PCF for the UE 10. The AMF receives the indication such as policy capability information from NRF, as described in the tables above. The AMF interacts with UDR and may select a PCF supporting slice specific N3IWF/TNGF policy delivery during registration procedure.
9. The AMF initiates a UE policy association. The AMF indicates that the policy association is established to provide updated UE policies related to N3IWF and/or TNGF selection. The AMF may also provide the needed S-NSSAIs. Step 9a-9b. The UE 10 may request UE policy association establishment with the indication indicating that policy for N3IWF selection is needed, S-NSSAIs, by providing an indication that policy for N3IWF is needed and may provide indication(s) of requested S-NSSAI(s). The PCF may reply with requested S-NSSAI(s).
10a. AMF sends a Registration Reject message to the UE 10. Optionally, if the AMF has determined in step 8 that the selected N3IWF is not appropriate, the AMF may provide target N3IWF information (e.g. FQDN and/or IP address) to UE within Registration Reject message Case b): S-N3IWF is appropriate:
10.b If the AMF has determined in step 8 that the selected N3IWF is appropriate, AMF continues the registration procedure as defined in clause 4.12.2.2 and sends a Registration Accept to the UE 10. AMF only includes S-NSSAIs supported by the selected N3IWF in the Accepted NSSAI for the UE 10. (id the S-N3IWF is appropriate). The N3IWF forwards the NAS Registration Accept message to UE via the established signalling IPsec SA. If the NAS Registration Accept message is received by the N3IWF before the Ipsec SA is established, the N3IWF shall store it and forward it to the UE 10 only after the establishment of the signalling IPsec SA.
11. If the UE 10 is rejected, the UE 10 connects to T-N3IWF if the UE 10 has been provided with T-N3IWF information in the previous Registration Reject, otherwise the UE 10 performs N3IWF selection again using the updated N3IWF selection information.

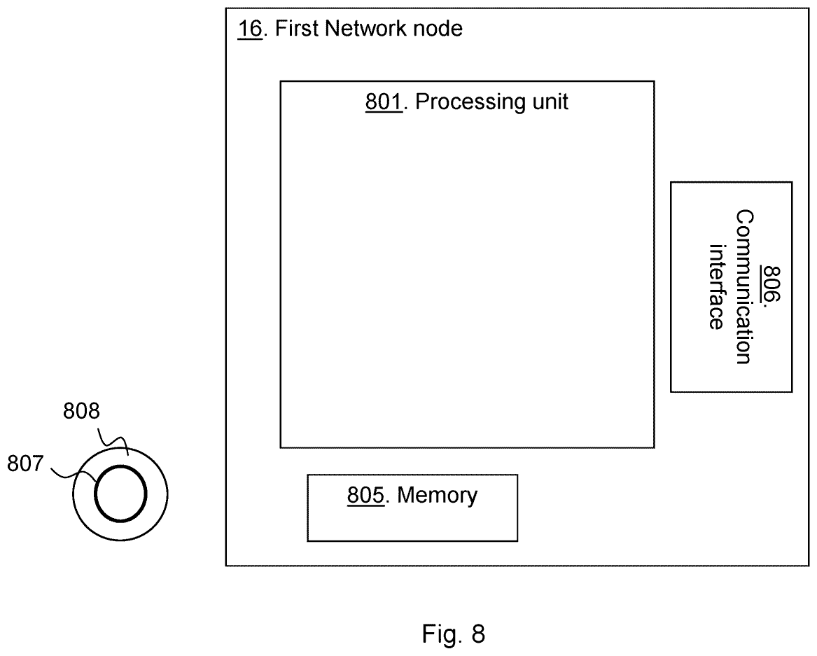

FIG. 8 is a block diagram depicting the first network node 16, such as an NRF, for handling communication of the UE 10 in the communication network 1 according to embodiments herein.

The first network node 16 may comprise processing circuitry 801, e.g. one or more processors, configured to perform the methods herein.

The first network node 16 and/or the processing circuitry 801 is configured to register the supported slice specific policy delivery of the network function or the third network node 18. For example, the first network node 16 and/or the processing circuitry 801 may be configured to store a capability indication that indicates that a network function or the third network node 18, such as a PCF, supports slice specific policy delivery.

The first network node 16 and/or the processing circuitry 801 is configured to provide to the second network node 17 the indication of the supported slice specific policy delivery of the network function or the third network node 18. The indication may be included in a PCF profile in the first network node 16 and may be sent to the second network node 17 upon request. The indication may comprise a real value or an index value of a configured table/values. The indication may comprise a simple Boolean indicating of the third network node 18 supports slice-specific N3IWF and/or TNGF selection policies. This would then imply that the third network node 18 supports all the required functionality related to slice-specific N3IWF and/or TNGF policies. The indication may comprise a simple Boolean indicating of the third network node 18 supports delivery of UE policies, such as ANDSP, during the Registration procedure. This is the capability from the second network node 17 perspective when selecting UE third network node 18 in this scenario. The indication may comprise a structured IE indicating separate values for different functionalities. There may be separate capability indications such as: a first value indicating that PCF supports delivery of UE policies (ANDSP) for N3IWF selection during the Registration procedure; a second value indicating that PCF supports delivery of UE policies (ANDSP) for TNGF selection during the Registration procedure; a third value indicating that PCF supports delivery of UE policies (WLANSP) for SSID selection during the Registration procedure.

The first network node 16 may comprise a memory 805. The memory 805 comprises one or more units to be used to store data on, such as data packets, indications of supported specific policy delivery, events and applications to perform the methods disclosed herein when being executed, and similar. Furthermore, the first network node 16 may comprise a communication interface 806 such as comprising a transmitter, a receiver, a transceiver and/or one or more antennas.

The methods according to the embodiments described herein for the first network node 16 are respectively implemented by means of e.g. a computer program product 807 or a computer program, comprising instructions, i.e., software code portions, which, when executed on at least one processor, cause the at least one processor to carry out the actions described herein, as performed by the first network node 16. The computer program product 807 may be stored on a computer-readable storage medium 808, e.g., a disc, a universal serial bus (USB) stick or similar. The computer-readable storage medium 808, having stored thereon the computer program product, may comprise the instructions which, when executed on at least one processor, cause the at least one processor to carry out the actions described herein, as performed by the first network node 16. In some embodiments, the computer-readable storage medium may be a transitory or a non-transitory computer-readable storage medium. Thus, embodiments herein may disclose the first network node for handling communication of the UE in a communication network, wherein the first network node comprises processing circuitry and a memory, said memory comprising instructions executable by said processing circuitry whereby said first network node is operative to perform any of the methods herein.

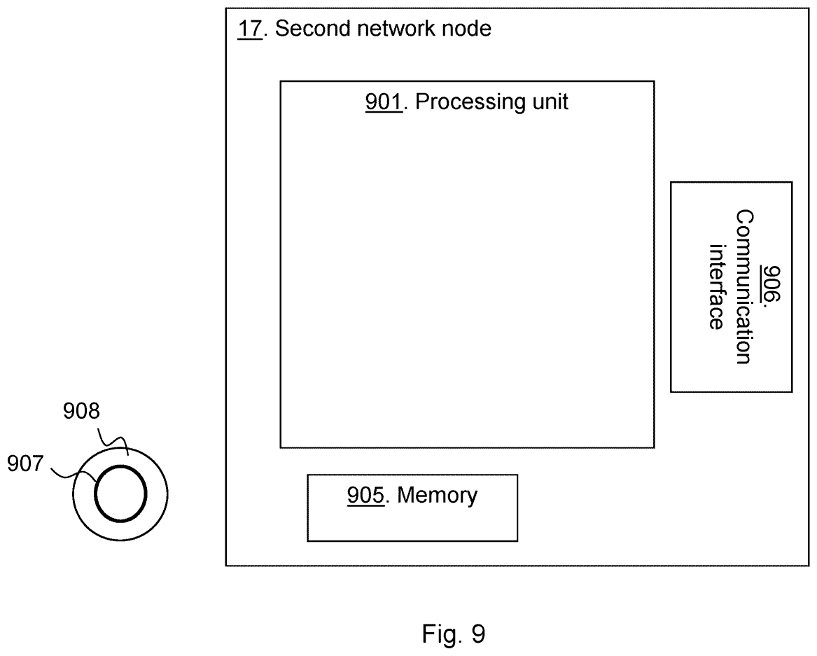

FIG. 9 is a block diagram depicting the second network node 17, such as an AMF, for handling communication of the UE 10 in the communication network 1 according to embodiments herein.

The second network node 17 may comprise processing circuitry 901, e.g. one or more processors, configured to perform the methods herein.

The second network node 17 and/or the processing circuitry 901 may be configured to request from the first network node 16 for supported slice specific policy delivery.

The second network node 17 and/or the processing circuitry 901 is configured to obtain from the first network node 16 the indication of the supported slice specific policy delivery of the third network node 18. The indication may indicate that the third network node 18 supports slice-specific N3IWF and TNGF selection policies. The indication may comprise a real value or an index value of a configured table/values, see above. The indication may comprise a real value or an index value of a configured table/values. The indication may comprise a simple Boolean indicating of the third network node 18 supports slice-specific N3IWF and/or TNGF selection policies. This would then imply that the third network node 18 supports all the required functionality related to slice-specific N3IWF and/or TNGF policies. The indication may comprise a simple Boolean indicating of the third network node 18 supports delivery of UE policies, such as ANDSP, during the Registration procedure. The indication may comprise the structured IE indicating separate values for different functionalities. There may be separate capability indications such as: a first value indicating that PCF supports delivery of UE policies (ANDSP) for N3IWF selection during the Registration procedure; a second value indicating that PCF supports delivery of UE policies (ANDSP) for TNGF selection during the Registration procedure; a third value indicating that PCF supports delivery of UE policies (WLANSP) for SSID selection during the Registration procedure.

The second network node 17 and/or the processing circuitry 901 may be configured to select a third network node 18 such as PCF supporting a specific slice specific policy delivery based on the obtained indication.

The second network node 17 and/or the processing circuitry 901 may be configured to provide, e.g., transmit, to the third network node such as the PCF, the additional indication to inform the third network node that a UE policy is established for a purpose of untrusted non-3GPP access selection. The second network node 17 and/or the processing circuitry 901 may be configured to further provide information such as the further indication in case of trusted non-3GPP access, in that case the second network node may transmit the further indication of deliver policy for SSID selection, such as WLANSP, and TNGF selection, such as ANDSP. The second network node 17 and/or the processing circuitry 901 may be configured to transmit the one or more indications of targeted S-NSSAIs, as determined from the requested NSSAI, that are needed by the UE 10. This can guide the PCF to limit the amount of policies sent to the UE 10.

The second network node 17 may comprise a memory 905. The memory 905 comprises one or more units to be used to store data on, such as data packets, indications of supported specific policy delivery, further indications, information, events and applications to perform the methods disclosed herein when being executed, and similar. Furthermore, the second network node 17 may comprise a communication interface 906 such as comprising a transmitter, a receiver, a transceiver and/or one or more antennas.

The methods according to the embodiments described herein for the second network node 17 are respectively implemented by means of e.g. a computer program product 907 or a computer program, comprising instructions, i.e., software code portions, which, when executed on at least one processor, cause the at least one processor to carry out the actions described herein, as performed by the second network node 17. The computer program product 907 may be stored on a computer-readable storage medium 908, e.g., a disc, a universal serial bus (USB) stick or similar. The computer-readable storage medium 908, having stored thereon the computer program product, may comprise the instructions which, when executed on at least one processor, cause the at least one processor to carry out the actions described herein, as performed by the second network node 17. In some embodiments, the computer-readable storage medium may be a transitory or a non-transitory computer-readable storage medium. Thus, embodiments herein may disclose the second network node for handling communication of the UE in a communication network, wherein the second network node comprises processing circuitry and a memory, said memory comprising instructions executable by said processing circuitry whereby said second network node is operative to perform any of the methods herein.

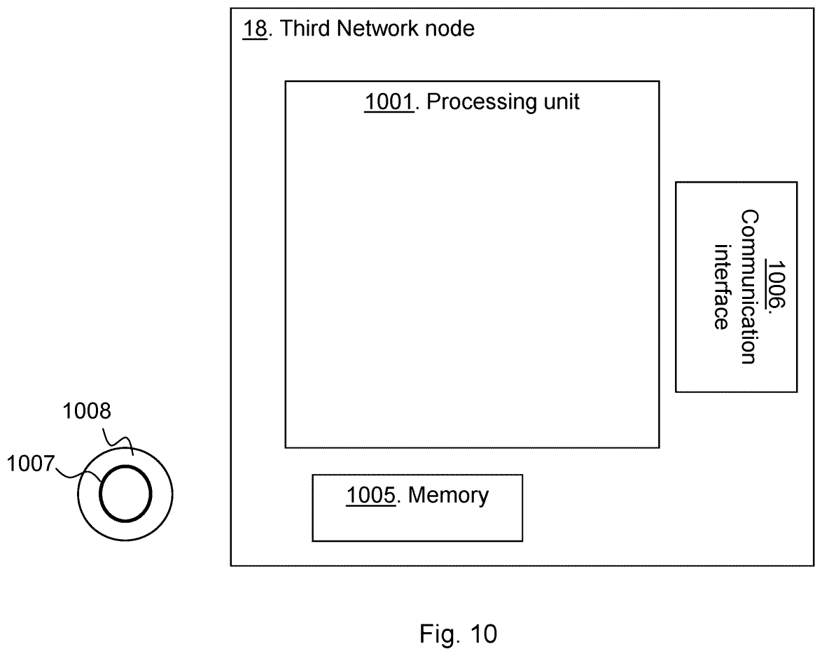

FIG. 10 is a block diagram depicting the third network node 18, such as a PCF, for handling communication of the UE 10 in the communication network 1 according to embodiments herein.

The third network node 18 may comprise processing circuitry 1001, e.g. one or more processors, configured to perform the methods herein.

The third network node 18 and/or the processing circuitry 1001 is configured to obtain, from the second network node 17 such as the AMF, the additional indication to inform the third network node that a UE policy is established for a purpose of untrusted non-3GPP access selection. The third network node 18 and/or the processing circuitry 1001 may be configured to receive information such as a further indication in case of trusted non-3GPP access, in that case the third network node 18 may receive the further indication of deliver policy for service set identifier (SSID) selection, such as WLANSP, and TNGF selection, such as ANDSP. The third network node 18 may further receive one or more indications of targeted S-NSSAIs, as determined from the Requested NSSAI, that are needed by the UE 10. This can guide the PCF to limit the amount of policies sent to the UE 10.

The third network node 18 and/or the processing circuitry 1001 may be configured to transmit to the UE 10 one or more indications of targeted S-NSSAIs, as determined from requested NSSAI, that are needed by the UE 10. The additional indication and/or the one or more indications may comprise a real value or an index value of a configured table/values.

The third network node 18 may comprise a memory 1005. The memory 1005 comprises one or more units to be used to store data on, such as data packets, indications of supported specific policy delivery, further indications, additional indications, indications, information, events and applications to perform the methods disclosed herein when being executed, and similar. Furthermore, the third network node 18 may comprise a communication interface 1006 such as comprising a transmitter, a receiver, a transceiver and/or one or more antennas.

The methods according to the embodiments described herein for the third network node 18 are respectively implemented by means of e.g. a computer program product 1007 or a computer program, comprising instructions, i.e., software code portions, which, when executed on at least one processor, cause the at least one processor to carry out the actions described herein, as performed by the third network node 18. The computer program product 1007 may be stored on a computer-readable storage medium 1008, e.g., a disc, a universal serial bus (USB) stick or similar. The computer-readable storage medium 1008, having stored thereon the computer program product, may comprise the instructions which, when executed on at least one processor, cause the at least one processor to carry out the actions described herein, as performed by the third network node 18. In some embodiments, the computer-readable storage medium may be a transitory or a non-transitory computer-readable storage medium. Thus, embodiments herein may disclose the third network node for handling communication of the UE in a communication network, wherein the third network node comprises processing circuitry and a memory, said memory comprising instructions executable by said processing circuitry whereby said third network node is operative to perform any of the methods herein.

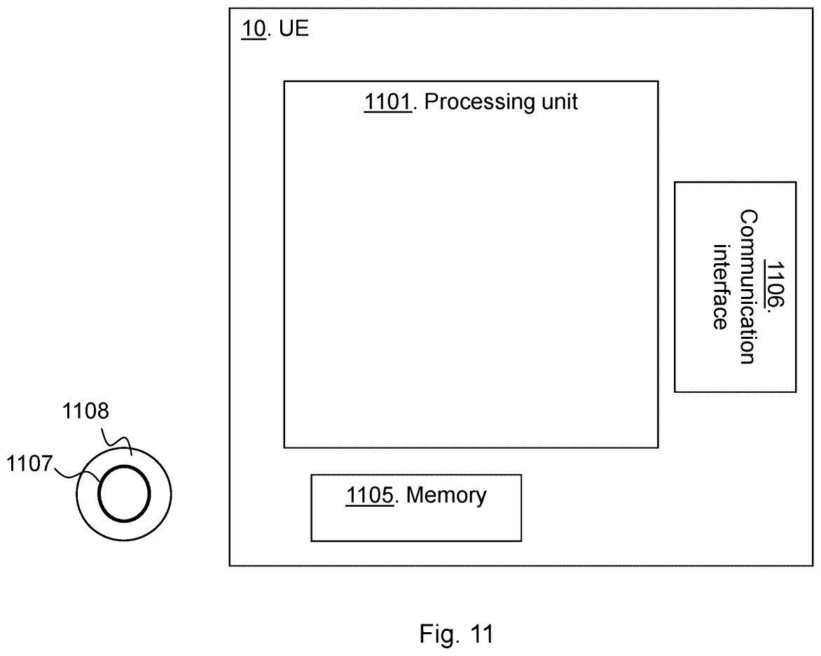

FIG. 11 is a block diagram depicting the UE 10, in two embodiments, for handling communication of the UE 10 in the communication network 1 according to embodiments herein.

The UE 10 may comprise processing circuitry 1101, e.g., one or more processors, configured to perform the methods herein.

The UE 10 and/or the processing circuitry 1101 is configured to transmit the one or more access indications, which access indications indicate that policy for trusted or untrusted non-3GPP Access Network such as N3IWF is needed or requested, and to provide a request indication(s) of one or more requested S-NSSAIs. The access indication may comprise a real value or an index value of a configured table/values.

The UE 10 and/or the processing circuitry 1101 may be configured to receive the one or more indications of targeted S-NSSAIs, as determined from the requested NSSAI, that are needed by the UE 10. The third network node 18, such as the PCF, may reply with requested S-NSSAI(s). The one or more indications may comprise a real value or an index value of a configured table/values.

The UE 10 may comprise a memory 1105. The memory 1105 comprises one or more units to be used to store data on, such as data packets, access indications, policies, signal strengths/qualities, measurements, indications, PLMN IDs, SIP messages, events and applications to perform the methods disclosed herein when being executed, and similar. Furthermore, the UE 10 may comprise a communication interface 1106 such as comprising a transmitter, a receiver, a transceiver and/or one or more antennas.

The methods according to the embodiments described herein for the UE 10 are respectively implemented by means of e.g. a computer program product 1107 or a computer program, comprising instructions, i.e., software code portions, which, when executed on at least one processor, cause the at least one processor to carry out the actions described herein, as performed by the UE 10. The computer program product 1107 may be stored on a computer-readable storage medium 1108, e.g. a disc, a universal serial bus (USB) stick or similar. The computer-readable storage medium 1108, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a communication network, wherein the UE 10 comprises processing circuitry and a memory, said memory comprising instructions executable by said processing circuitry whereby said UE 10 is operative to perform any of the methods herein.

In some embodiments a more general term “network node” is used and it can correspond to any type of radio-network node or any network node, which communicates with a UE and/or with another network node.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), IoT capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals, e.g., data, e.g. NR, Wi-Fi, LTE, LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

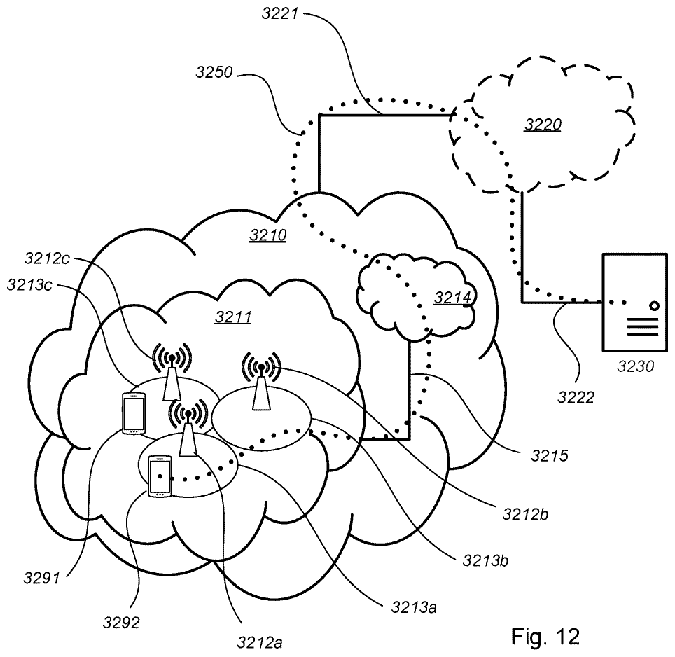

With reference to FIG. 12, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

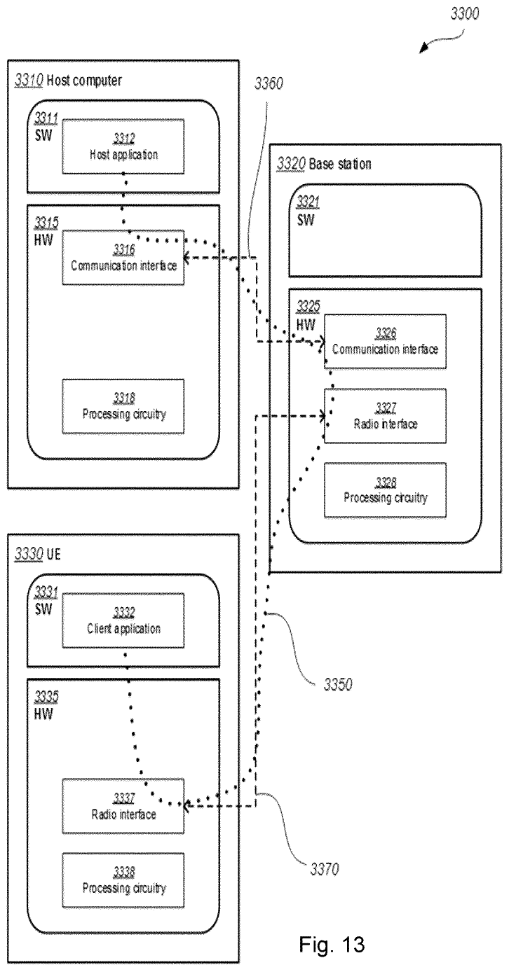

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since access may be handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

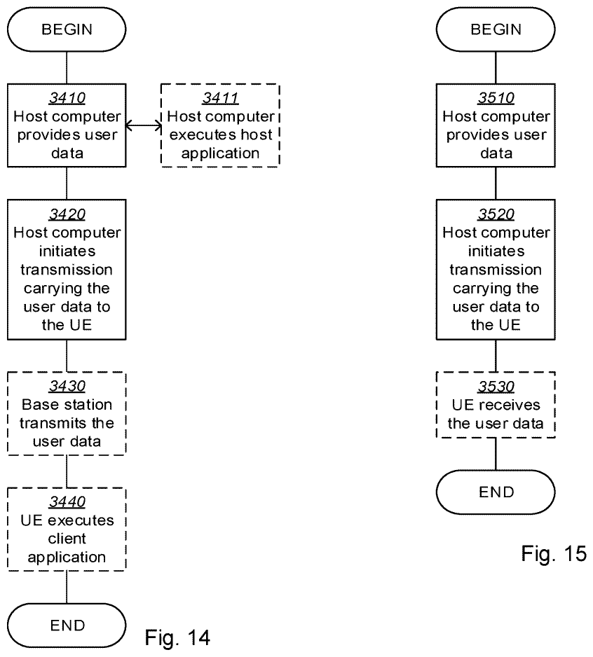

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

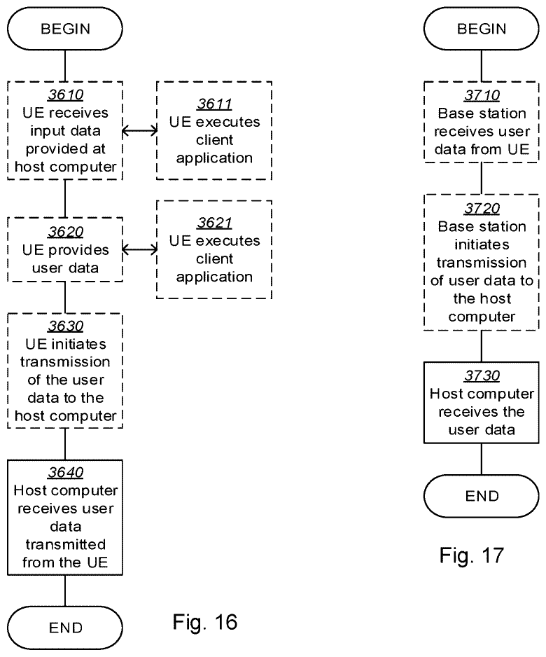

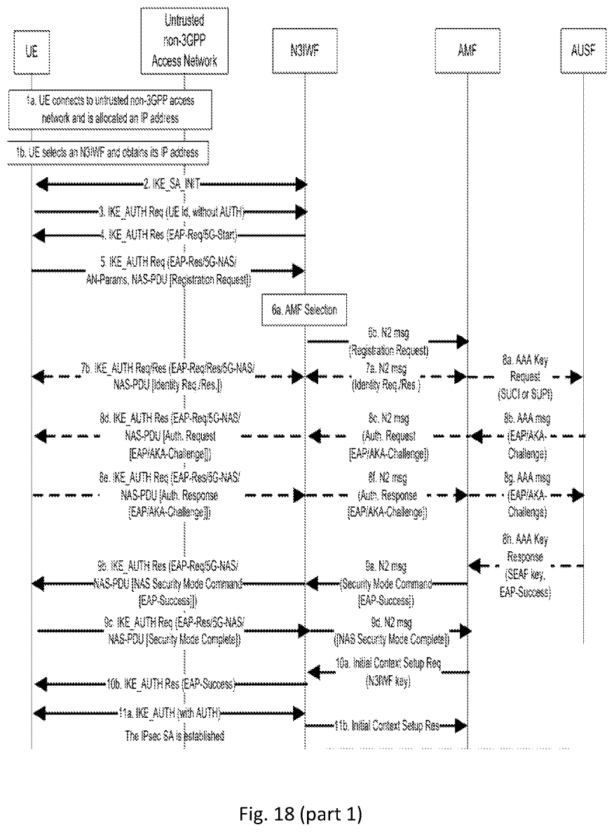

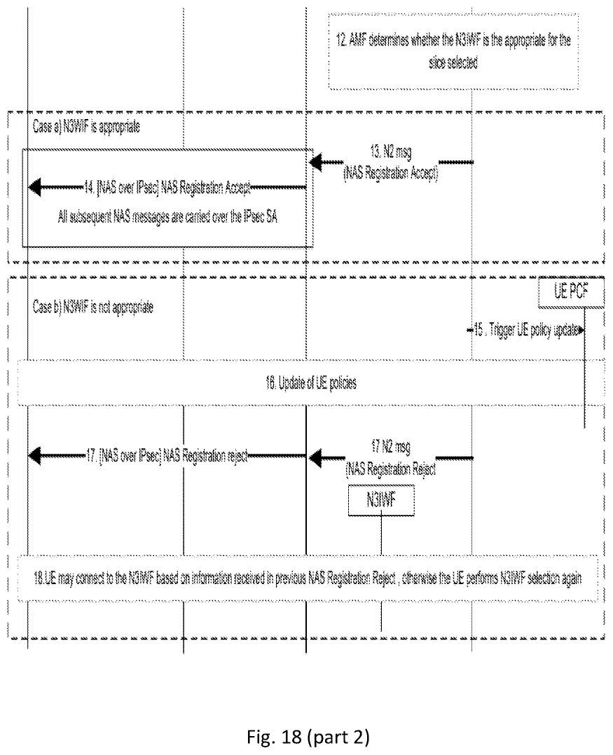

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

### EMBODIMENTS

### Embodiment A1

A method performed by a first network node, such as the NRF, for handling communication of a UE 10 in a communication network, the method comprising registering a supported slice specific policy delivery of a network function, and providing to a second network node an indication of the supported slice specific policy delivery of the network function.

### Embodiment A2

The method according to embodiment A1, wherein the indication is included in a PCF profile in the first network node.

### Embodiment A3

The method according to embodiment A1, wherein the first network node stores a capability indication that indicates that the network function supports slice specific policy delivery.

### Embodiment B1

A method performed by a second network node, such as the AMF, for handling communication of a UE 10 in a communication network, the method comprising obtaining from a first network node an indication of a supported slice specific policy delivery of a third network node or network function.

### Embodiment B2

The method according to embodiment B1, wherein the indication indicates that the third network node supports slice-specific N3IWF and TNGF selection policies.

### Embodiment B3

The method according to any of the embodiments B1-B2, further comprising receiving a request from the first network node for supported slice specific policy delivery.

### Embodiment B4

The method according to any of the embodiments B1-B3, further comprising selecting a network function such as PCF supporting a specific slice specific policy delivery.

### Embodiment B5

The method according to any of the embodiments B1-B4, further comprising providing, to the third network node such as the PCF, an additional indication to inform the third network node that a UE policy is established for a purpose of untrusted non-3GPP access selection.

### Embodiment C1

A method performed by a third network node, such as the PCF, for handling communication of a UE 10 in a communication network, the method comprising obtaining, from a second network node such as the AMF, an additional indication to inform the third network node that a UE policy is established for a purpose of untrusted non-3GPP access selection.

### Embodiment C2

The method according to embodiment C1, further comprising
transmitting to the UE one or more indications of targeted S-NSSAIs, as determined from Requested NSSAI, that are needed by the UE.

### Embodiment D1

A method performed by a UE for handling communication of the UE 10 in a communication network, the method comprising
transmitting one or more access indications, which one or more access indications indicate that policy for trusted or untrusted non-3GPP Access Network such as N3IWF is needed or requested.

### Embodiment D2

The method according to embodiment D1, further comprising
receiving one or more indications of targeted S-NSSAIs, as determined from Requested NSSAI, that are needed by the UE.

1. A method performed by a first network node (16) for handling communication of a user equipment, UE, (10) in a communication network, the method comprising:
registering (301) a supported slice specific policy delivery of a third network node (18); and
providing (302) to a second network node (17) an indication of the supported slice specific policy delivery of the third network node (18).

2. The method according to claim 1, wherein registering (301) the supported slice specific policy delivery comprises storing a capability indication that indicates that the third network node supports slice specific non-3GPP Inter-Working Function, N3IWF, and/or trusted Non-3GPP Gateway Function, TNGF, policy delivery.

3. The method according to any of the claims 1-2, wherein the indication is included in a Policy Control Function, PCF, profile in the first network node and is sent to the second network node upon request.

4. The method according to any of the claims 1-3, wherein the indication comprises a simple Boolean indicating of support of slice-specific non-3GPP Inter-Working Function, N3IWF, and/or trusted Non-3GPP Gateway Function, TNGF, selection policies.

5. The method according to any of the claims 1-4, wherein the indication comprises a structured information element, IE, indicating separate values for different functionalities, wherein a first value indicates that Policy Control Function, PCF, supports delivery of UE policies for non-3GPP Inter-Working Function, N3IWF, selection during the Registration procedure; a second value indicates that PCF supports delivery of UE policies for trusted Non-3GPP Gateway Function, TNGF, selection during the Registration procedure; a third value indicates that PCF supports delivery of UE policies for service set identifier, SSID, selection during the Registration procedure.

6. A method performed by a second network node (17) for handling communication of a user equipment, UE, (10) in a communication network, the method comprising:
obtaining (402) from a first network node an indication of a supported slice specific policy delivery of a third network node.

7. The method according to claim 6, further comprising:
selecting (403) the third network node supporting a specific slice specific policy delivery based on the indication.

8. The method according to any of the claims 6-7, further comprising:
providing (404) to the third network node, an additional indication to inform the third network node that a UE policy is established for a purpose of untrusted non-3GPP access selection.

9. The method according to any of the claims 6-8, further comprising:
requesting (401) from the first network node for supported slice specific policy delivery.

10. The method according to any of the claims 6-9, wherein the indication comprises a simple Boolean indicating of support of slice-specific non-3GPP Inter-Working Function, N3IWF, and/or trusted Non-3GPP Gateway Function, TNGF, selection policies.

11. The method according to any of the claims 6-10, wherein the indication comprises a structured information element, IE, indicating separate values for different functionalities, wherein a first value indicates that Policy Control Function, PCF, supports delivery of UE policies for non-3GPP Inter-Working Function, N3IWF, selection during the Registration procedure; a second value indicates that PCF supports delivery of UE policies for trusted Non-3GPP Gateway Function, TNGF, selection during the Registration procedure; a third value indicates that PCF supports delivery of UE policies for service set identifier, SSID, selection during the Registration procedure.

12. A method performed by a third network node for handling communication of a user equipment, UE, (10) in a communication network, the method comprising:
obtaining (501), from a second network node, an additional indication to inform a third network node that a UE policy is established for a purpose of untrusted non-3GPP access selection.

13. The method according to claim 12, wherein obtaining the additional indication comprises receiving information in case of trusted non-3GPP access, in that case the third network node receives a further indication of deliver policy for service set identifier, SSID, selection and TNGF selection.

14. The method according to any of the claims 12-13, further comprising:
transmitting to the UE, one or more indications of targeted Serving Network Slice Selection Assistance Information, S-NSSAI, as determined from Requested NSSAI, that are needed by the UE.

15. A method performed by a user equipment, UE, (10) for handling communication of the UE (10) in a communication network, the method comprising:
transmitting (601) one or more access indications, which one or more access indications indicate that policy for trusted or untrusted non-3GPP Access Network is needed or requested and provides a request indication of requested Serving Network Slice Selection Assistance Information, S-NSSAI.

16. The method according to claim 15, further comprising:
receiving (602) one or more indications of targeted Serving Network Slice Selection Assistance Information, S-NSSAI, as determined from the requested NSSAI, that are needed by the UE (10).

17. A first network node (16) for handling communication of a user equipment, UE, (10) in a communication network, wherein the first network node (16) is configured to:
register a supported slice specific policy delivery of a third network node (18); and
provide to a second network node (17) an indication of the supported slice specific policy delivery of the third network node (18).

18. The first network node (16) according to claim 17, wherein the first network node (16) is configured to register the supported slice specific policy delivery by storing a capability indication that indicates that the third network node supports slice specific non-3GPP Inter-Working Function, N3IWF, and/or trusted Non-3GPP Gateway Function, TNGF, policy delivery.

19. The first network node (16) according to any of the claims 17-18, wherein the indication is included in a Policy Control Function, PCF, profile in the first network node and is sent to the second network node upon request.

20. The first network node (16) according to any of the claims 17-19, wherein the indication comprises a simple Boolean indicating of support of slice-specific non-3GPP Inter-Working Function, N3IWF, and/or trusted Non-3GPP Gateway Function, TNGF, selection policies.

21. The first network node (16) according to any of the claims 17-20, wherein the indication comprises a structured information element, IE, indicating separate values for different functionalities, wherein a first value indicates that Policy Control Function, PCF, supports delivery of UE policies for non-3GPP Inter-Working Function, N3IWF, selection during the Registration procedure; a second value indicates that PCF supports delivery of UE policies for trusted Non-3GPP Gateway Function, TNGF, selection during the Registration procedure; a third value indicates that PCF supports delivery of UE policies for service set identifier, SSID, selection during the Registration procedure.

22. A second network node (17) for handling communication of a user equipment, UE, (10) in a communication network, wherein the second network node is configured to:
obtain from a first network node an indication of a supported slice specific policy delivery of a third network node.

23. The second network node (17) according to claim 22, wherein the second network node is configured to:
select the third network node supporting a specific slice specific policy delivery based on the indication.

24. The second network node (17) according to any of the claims 22-23, wherein
the second network node is configured to:
provide to the third network node, an additional indication to inform the third network node that a UE policy is established for a purpose of untrusted non-3GPP access selection.

25. The second network node (17) according to any of the claims 22-23, wherein the second network node is configured to:
request from the first network node for supported slice specific policy delivery.

26. The second network node (17) according to any of the claims 22-25, wherein the indication comprises a simple Boolean indicating of support of slice-specific non-3GPP Inter-Working Function, N3IWF, and/or trusted Non-3GPP Gateway Function, TNGF, selection policies.

27. The second network node (17) according to any of the claims 22-26, wherein the indication comprises a structured information element, IE, indicating separate values for different functionalities, wherein a first value indicates that Policy Control Function, PCF, supports delivery of UE policies for non-3GPP Inter-Working Function, N3IWF, selection during the Registration procedure; a second value indicates that PCF supports delivery of UE policies for trusted Non-3GPP Gateway Function, TNGF, selection during the Registration procedure; a third value indicates that PCF supports delivery of UE policies for service set identifier, SSID, selection during the Registration procedure.

28. A third network node for handling communication of a user equipment, UE, (10) in a communication network, wherein the third network node is configured to:
obtain, from a second network node, an additional indication to inform the third network node that a UE policy is established for a purpose of untrusted non-3GPP access selection.

29. The third network node according to claim 28, wherein the third network node is configured to obtain the additional indication by receiving information in case of trusted non-3GPP access, in that case the third network node receives a further indication of deliver policy for service set identifier, SSID, selection, and TNGF selection.

30. The third network node according to any of the claims 28-29, wherein the third network node is configured to transmit to the UE, one or more indications of targeted Serving Network Slice Selection Assistance Information, S-NSSAI, as determined from Requested NSSAI, that are needed by the UE.

31. A user equipment, UE, (10) for handling communication of the UE (10) in a communication network, wherein the UE is configured to:
transmit one or more access indications, which one or more access indications indicate that policy for trusted or untrusted non-3GPP Access Network is needed or requested and to provide indication of requested Serving Network Slice Selection Assistance Information, S-NSSAI.

32. The UE according to claim 31, wherein the UE is configured to:
receive one or more indications of targeted Serving Network Slice Selection Assistance Information, S-NSSAI, as determined from the requested S-NSSAI, that are needed by the UE (10).

33. A computer program product comprising instructions, which, when executed on at least one processor, cause the at least one processor to carry out the method according to any of the claims 1-16, as performed by the UE, the first network node, the second network node, and the third network node, respectively.

34. A computer-readable storage medium, having stored thereon a computer program product comprising instructions which, when executed on at least one processor, cause the at least one processor to carry out the method according to any of the claims 1-16, as performed by the UE, the first network node, the second network node, and the third network node, respectively.
